(19) United States
(12) Patent Application Publication
(10) Pub. No.: US 2021/0114197 A1
(43) Pub. Date: Apr. 22, 2021

(54) HANDHELD ELECTRIC POWER TOOL

(71) Applicant: C. & E. Fein GmbH, Schwaebisch Gmuend-Bargau (DE)

(72) Inventor: Rainer MANN, Aalen-Dewangen (DE)

(73) Assignee: C. & E. Fein GmbH, Schwaebisch Gmuend-Bargau (DE)

(21) Appl. No.: 17/076,646

(22) Filed: Oct. 21, 2020

(30) Foreign Application Priority Data
Oct. 21, 2019 (DE) 20 2019 105 846.3

(51) Int. Cl. B25F 5/02; B25F 3/00; B23Q 11/00; B25H 1/00; B23Q 3/00

(52) U.S. Cl. CPC B25F 5/02; B25F 3/00; B23Q 11/0046; B23D 61/006; B25H 1/005; B23Q 3/005; B23Q 11/0071

(57) ABSTRACT

A handheld electric power tool that is adapted to be driven in oscillation, the handheld electric power tool having a housing and a drive arranged in the housing for driving a toolholder, which is arranged on a tool shaft coupled to the drive and on which a tool is detachably installed. The tool shaft is accommodated in an output unit, which includes a gearhead accommodated in a gearhead housing, and a collar, which is designed so as to make possible a tool-free seating of an attachment in an installation direction oriented parallel to a longitudinal axis of the gearhead, is formed on the output unit.

This nonprovisional application claims priority under 35 U.S.C. § 119(a) to German Patent Application No. 20 2019 105 846.3, which was filed in Germany on Oct. 21, 2019, and which is herein incorporated by reference.

### BACKGROUND OF THE INVENTION

### Field of the Invention

The present invention relates to a handheld electric power tool, in particular a handheld electric power tool that can be driven in oscillation, having a housing and having a drive arranged in the housing for driving a toolholder, which is arranged on a tool shaft coupled to the drive and on which a tool can be detachably installed, wherein the tool shaft is accommodated in an output unit, which includes a gearhead preferably accommodated in a gearhead housing.

### Description of the Background Art

Handheld electric power tools that are driven in oscillation, or in other words in which a rotation of the drive shaft produced by an electric drive is converted into an oscillating motion of the toolholder connected to the tool shaft, frequently are also referred to as oscillating multifunction tools (OMT). It should also be noted in this regard that the tool shaft is usually oriented perpendicular to the drive in OMT tools. It is possible to mount on this toolholder of the handheld electric power tools an extremely wide variety of tools, with which it is possible to process workpieces, especially workpieces made of wood, for which reason these power tools are very versatile and thus enjoy great popularity.

In this context, it has become evident that it is necessary to give the user the option of being able to mount on the handheld electric power tool additional attachments apart from the tool. For instance, the dusts and chips that are produced, especially when abrasive plates and saw blades are being used, are extremely disadvantageous for the user. On the one hand, they can obstruct the view of the work area, which can have an adverse effect on the work result, but on the other hand the problem also exists that these dusts and chips can be inhaled by the user or can get into the user's eyes, which then in turn has an adverse effect on the user's health. For this reason, suction devices, which draw off the dusts and chips produced during processing of the workpiece and thereby keep them away from the user and the work area, are often used as attachments for these types of work. In addition, however, it has often proven useful during sawing for a depth stop to be used, which makes it possible to limit the penetration depth of the saw blade in the workpiece.

Finally, the term output unit can be understood within the framework of the invention as the part of the handheld electric power tools in which or on which the important oscillating components of the machine are accommodated or arranged, which is to say, in particular, the tool shaft and the toolholder on which the tool is mounted.

The gearhead, which usually is made of metal, houses the tool shaft, which is driven in oscillation, and the gearhead housing, which often is made of plastic, at least partially encloses the gearhead. Gearheads that are designed without an additional gearhead housing are also possible, however.

In the case of handheld electric power tools that can be driven in oscillation and that have a modern toolholder such as is disclosed in, e.g., EP 3027367 A1, (which corresponds to U.S. Pat. No. 10,052,695, which is incorporated herein by reference) tool change can be accomplished very quickly. One problem with the attachments known from the prior art, however, is the mounting of the attachment on the handheld electric power tool. Thus a table holder, for example, which is screwed onto the gearhead, and which has appropriate threaded holes for this purpose, is known from DE 10 2016 110 214 A1, which is incorporated herein by reference. This design has indeed proven its worth and the threaded holes can also be used, in particular, for mounting other attachments.

However, in the conventional art, in order to change a relevant attachment, the screws that are used must always be loosened first and then tightened again after replacement of the attachment.

### SUMMARY OF THE INVENTION

It is therefore an object of the present invention to provide a handheld electric power tool that allows simplified changing of the attachments.

This object is attained according to the invention with a handheld electric power tool in that a collar, which is designed so as to make possible a tool-free seating of an attachment in an installation direction oriented parallel to a longitudinal axis of the gearhead, is formed on the output unit.

It is ensured by this means that an attachment can be placed on the collar as easily as possible, namely in the same direction as the tool.

It has also proven beneficial when the collar is associated with the gearhead or with the gearhead housing. By this means, the attachment can be mounted on the output unit especially securely, since the mounting takes place on a structurally secure component here. Provision is also made within the scope of the invention, however, that the attachment is associated with the gearhead and the gearhead housing.

It has also proven worthwhile here when the collar is formed as a single piece with the gearhead or the gearhead housing. The installation effort is reduced perceptibly by this means, and manufacturing costs can thus also be reduced.

It has also proven especially advantageous when the collar has a cylindrical cross section. As a result of the cylindrical cross section, the attachments can be rotatably supported on the collar. This is important because the tools that are used with the handheld electric power tool can likewise be mounted in different angular positions on the toolholder.

It has been shown to be beneficial, moreover, when the collar is delimited at its end pointing toward the toolholder by a collet. This reduces the risk that the attachment placed on the collar can slip axially toward the toolholder. There would otherwise be a risk of the attachment coming into contact with a tool accommodated in the toolholder, which could damage the attachment.

It has additionally proven especially beneficial when at least one recess is formed on the collet to produce an encoding. By this means, finally, it is only possible to place the attachment on the collar in one position, which further improves operational safety.

Furthermore, it has also proven advantageous when the at least one recess is provided in multiple instances. The mechanical stability of the connection of the attachment to the collar can be improved through the number of recesses, wherein it has proven especially worthwhile in this context when the number of recesses is preferably 2 or more, preferably greater than 4 or more, and especially preferably greater than 6 or more, and further preferably 14 or fewer, preferably 12 or fewer, and especially preferably 10 or fewer, and most especially preferably is 8. If the number of recesses were to be too great, then this would have an adverse effect on the mechanical stability of the collet.

It has additionally proven beneficial when the angular range of the total of the recesses is between 40° and 90°, and especially preferably is 60°. By this means, adequate stability of the collet is still ensured, and it is ensured at the same time that an attachment can be securely accommodated on the collar.

For manufacturing reasons, it has proven advantageous when the encoding has mirror-image symmetry about a plane of symmetry that is spanned by the housing longitudinal axis of the housing and the longitudinal axis of the gearhead. In this case it has also proven worthwhile when at least one of the recesses is intersected by the plane of symmetry.

It has also proven advantageous for operational safety, moreover, when the encoding produced by the at least one recess is designed such that a placement of an attachment can only take place in a position that is not normally employed for use of the attachment. This then achieves the result that unintentional detachment of the attachment, which would be detrimental to operational safety, is prevented. This is usually the case when there is an angle from 10° to 50° between the attachment and the housing longitudinal axis during installation of the attachment on the collar.

It has additionally proven advantageous for safety when the end of the collar pointing away from the toolholder is delimited by an annular band. The axial end position of the attachment is defined by the delimitation and it is additionally ensured as a result that the attachment can only move to a limited extent in the installed state.

It has also proven beneficial when detent seats are formed in the collar. By this means, it is possible to secure the attachments in the detent seats relative to their rotational position with a locking device. It has proven especially worthwhile in this case when the detent seats are formed in the annular band delimiting the collar. It has also been shown to be beneficial when adjacent detent seats are at an angle of 30° to one another. It should be explicitly noted here once again that the annular shoulders that delimit the collar, and the collet in which the recesses are formed that produce the encoding, are part of the collar.

It has also proven beneficial when an auxiliary ring, with which an attachment can be connected in a rotationally fixed manner, is associated with the collar in a freely rotatable and axially fixed manner. In this way, ultimately, an alternative or supplementary option for mounting the attachment is provided with which it is possible for the user to rotate it further than would be possible with the mounting through the encoding. In this context it has also proven worthwhile when the auxiliary ring has a radial opening. As a result, it is possible for the user to slightly widen the ring and place it on the collar over the collet. Here, too, the installation of the attachment on the collar takes place parallel to the longitudinal axis of the gearhead—which is to say parallel to the tool shaft.

For the installation of the attachment, it has proven beneficial in this case when at least one radial projection is associated with the auxiliary ring on its end pointing toward the toolholder. These projections can interact with locking gates, which are formed on the attachment, by which means the attachment can be secured on the auxiliary ring. In this case, six radial projections, in particular, have proven especially beneficial. Alternatively, however, provision is also made within the scope of the invention that at least one detent lug is associated with the auxiliary ring. This detent lug can then engage in a corresponding detent opening that is formed on the suction device. Provision is also made within the scope of the invention in this regard, however, that the detent opening is formed on the auxiliary ring and the detent lug is formed on the suction device.

In order to prevent tilting of an attachment installed on the auxiliary ring, it has been shown to be advantageous when an annular shoulder is associated with the auxiliary ring on its end pointing away from the toolholder. In this context, it has furthermore proven worthwhile when the annular shoulder at least partially covers the annular band. An additional guide is provided as a result.

The subject matter of the invention is additionally a combination of a handheld electric power tool according to one of claims 1 to 19 and an attachment that is detachably accommodated on the collar of the gearhead housing, wherein the attachment has a hollow cylindrical mounting section that can be coupled to the collar. Within the scope of the invention, hollow cylindrical should also be understood here to mean ring-shaped, in particular.

For mounting the attachment on the handheld electric power tool, it has also proven worthwhile, moreover, when a multiplicity of projections for interaction with the recesses of the collar, a multiplicity of locking gates for interaction with the radial projections formed on the auxiliary ring, or detent openings for interaction with the detent lugs formed on the auxiliary ring, are formed on the inner side of the hollow cylindrical mounting section. By this means, the attachment can be mounted on the collar especially easily.

The attachment can be selected from a group that includes a suction device, a depth stop, and/or a table support.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective view of a handheld electric power tool,

FIG. 2 shows a plan view from below of the handheld electric power tool from FIG. 1,

FIG. 3 shows a perspective view of a suction device,

FIG. 4 shows a perspective view of a suction device,

FIG. 5 shows a perspective view of a suction device,

FIG. 6 shows a perspective view of a suction device,

FIG. 7 shows a side view of a handheld electric power tool with the installed suction device according to the example from FIG. 6,

FIG. 8 shows a perspective view of a depth stop,

FIG. 9 shows a perspective view of a depth stop, and

FIG. 10 shows a perspective view of the suction device according to the example from FIG. 3, which is mounted on the handheld electric power tool.

### DETAILED DESCRIPTION

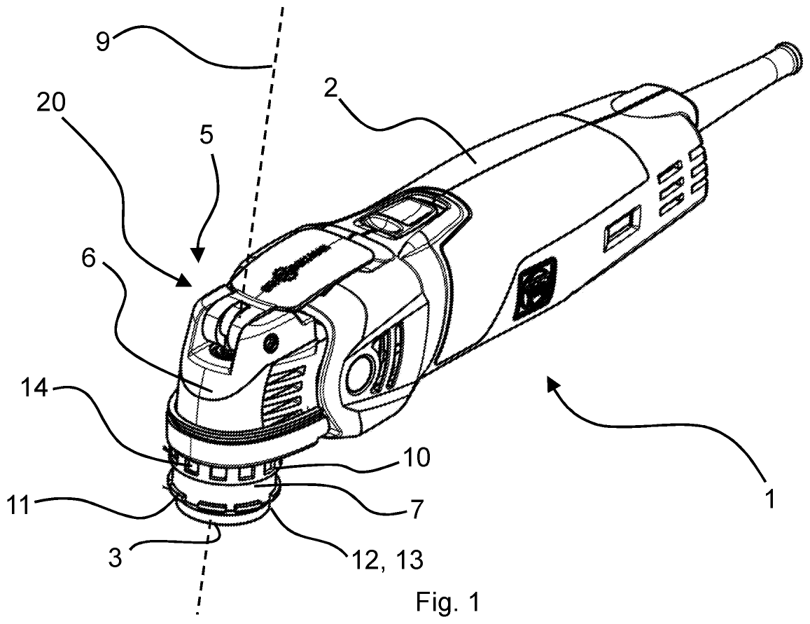

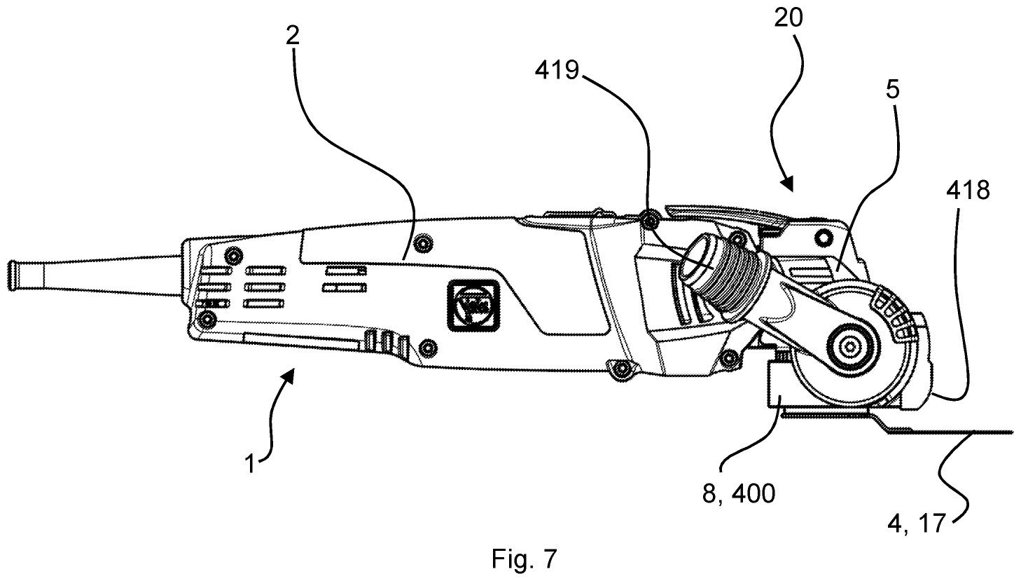

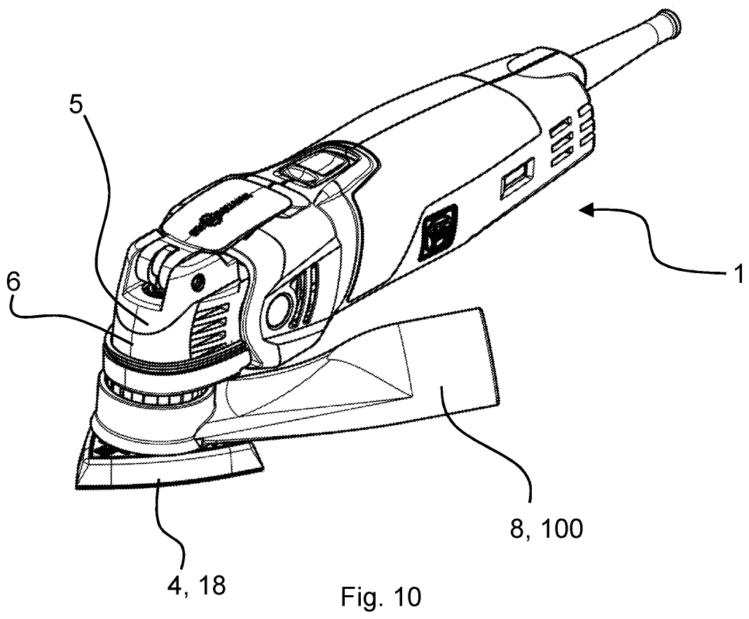

Shown in FIG. 1 in a perspective view is a handheld electric power tool 1 according to the invention, which can be driven in oscillation. This power tool has a housing 2, in which is accommodated a drive (not shown in the drawing) with which a toolholder 3 can be driven in oscillation by means of a tool shaft. The drive and the tool shaft are oriented perpendicular to one another in this case. A tool 4 can be detachably installed on the toolholder 3 here, as is evident from FIGS. 7 and 10, for example. The tool shaft is accommodated here in a gearhead 5, which is enclosed by a gearhead housing 6. These components are part of an output unit 20 here. The gearhead housing 6 in this case is formed as a single piece with a collar 7, which is designed so as to make possible a tool-free seating of an attachment 8, namely in an installation direction oriented parallel to a longitudinal axis 9 of the gearhead 5. The collar 7 in this case is delimited at its end pointing away from the toolholder 3 by an annular band 10 and at its end pointing toward the toolholder 3 by a collet 11, wherein multiple recesses 12 are formed on this collet 11, by which means an encoding 13 is created. It is ensured by means of this encoding 13 that the attachment 8 can only be in placed on the collar 7 and removed from it again in a certain position. In order to prevent unintentional detachment of the attachment 8, the recesses 13 are designed here such that a placing of an attachment 8 can only take place in a position that is not normally employed for use of the attachment 8. In the exemplary embodiment shown, a total of 8 recesses 12 are provided, wherein the angular range of the total of the recesses 12 is approximately 60°. In addition, detent seats 14 in which a locking device 415, 515 of an attachment 8 can engage are formed on the annular shoulder 10 in order to define the rotational position of the attachment on the collar 7.

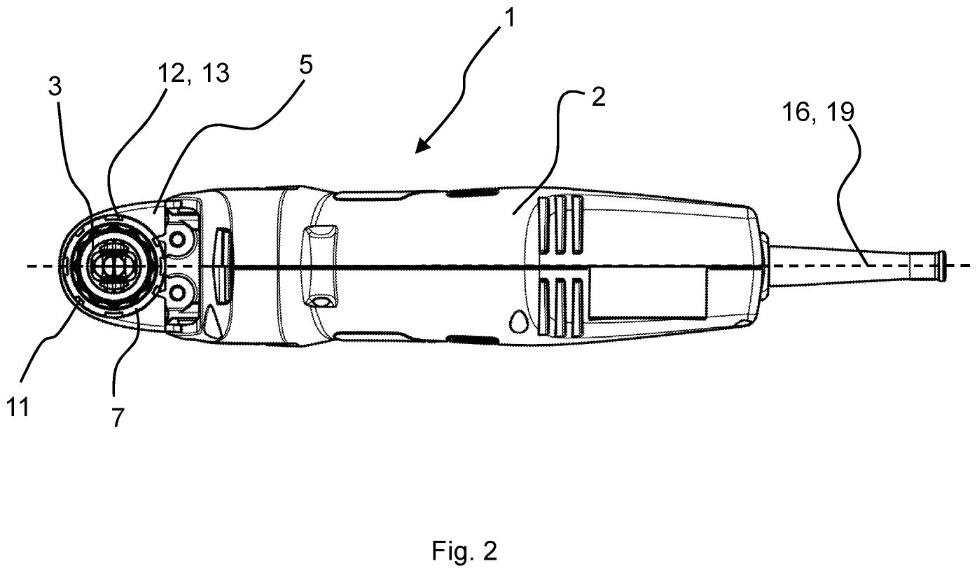

Evident in the bottom view of the handheld electric power tool 1 shown in FIG. 2, in addition to the toolholder 3, is that the collar 7 has a cylindrical cross section. Moreover, it can also be seen in this diagram that the recesses 13 have mirror-image symmetry about a plane of symmetry 16 that is spanned by a housing longitudinal axis 19 of the housing 2 and the longitudinal axis 9 of the gearhead 5. Furthermore, it is also evident here that at least one of the recesses 12 is intersected by the plane of symmetry 16. The recesses 12 are arranged here such that an attachment 8 can only be in placed on the collar 7 at an angle of approximately 45° relative to the housing longitudinal axis 19.

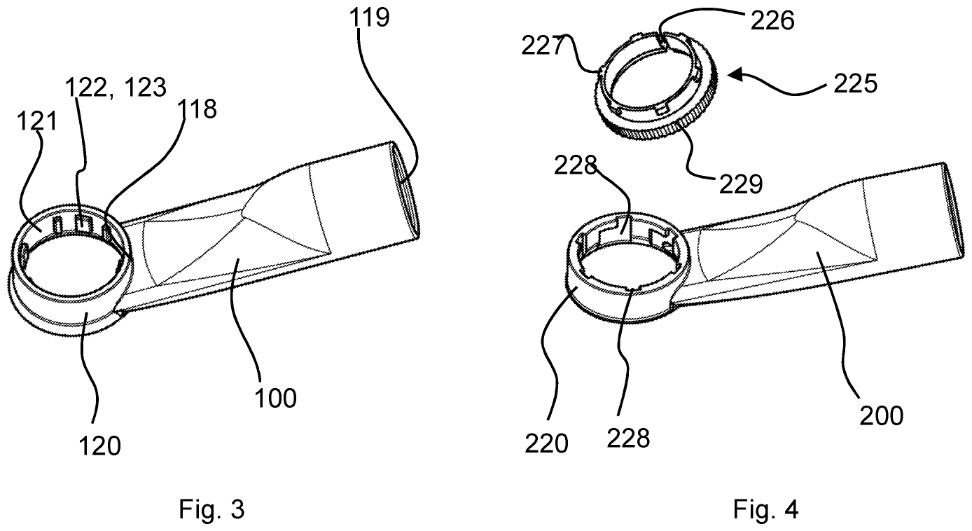

In FIG. 3, a first embodiment of a suction device 100 is shown that constitutes an attachment 8. In addition to an air inlet 118 and an air outlet 119, this suction device 100 has a hollow cylindrical mounting section 120 that the air inlet 118 opens into. In the first embodiment of the suction device 100, an encoding region 122 is formed on the inner side 121 of the hollow cylindrical mounting section 120 that is used for installation of the suction device 100 on the handheld electric power tool 1. This encoding region 122, which includes a number of projections 123, has the result that the suction device 100 can only be placed on the collar 7 of the handheld electric power tool 1 in a single position, namely only when the projections 123 of the encoding region 122 are aligned with corresponding recesses 12 that are formed on the collar 7 of the handheld electric power tool 1.

Visible in FIG. 4, in addition to the second embodiment of the suction device 200, is also an auxiliary ring 225, which can be placed in a freely rotatable manner on the collar 7 between the annular band 10 and the collet 11. For this purpose, the auxiliary ring 225 has a radial opening 226, by which means the auxiliary ring 225 can be slightly expanded by the user and placed on the collar 7 over the annular band 10. In order to mount the suction device 200 on the auxiliary ring 225, a total of 6 radial projections 227 are formed on the outer circumferential side on the end of the auxiliary ring 225 pointing toward the toolholder 3. Locking gates 228, which are formed on a mounting section 220 of the suction device 200, can engage in these radial projections 227 in order to connect the suction device 224 to the auxiliary ring 225 in a rotationally fixed manner. In the exemplary embodiment shown, an annular shoulder 229, which at least partially covers the annular band 10 that delimits the collar 7 axially to the rear, is associated with the auxiliary ring 225 on its end pointing away from the toolholder 3.

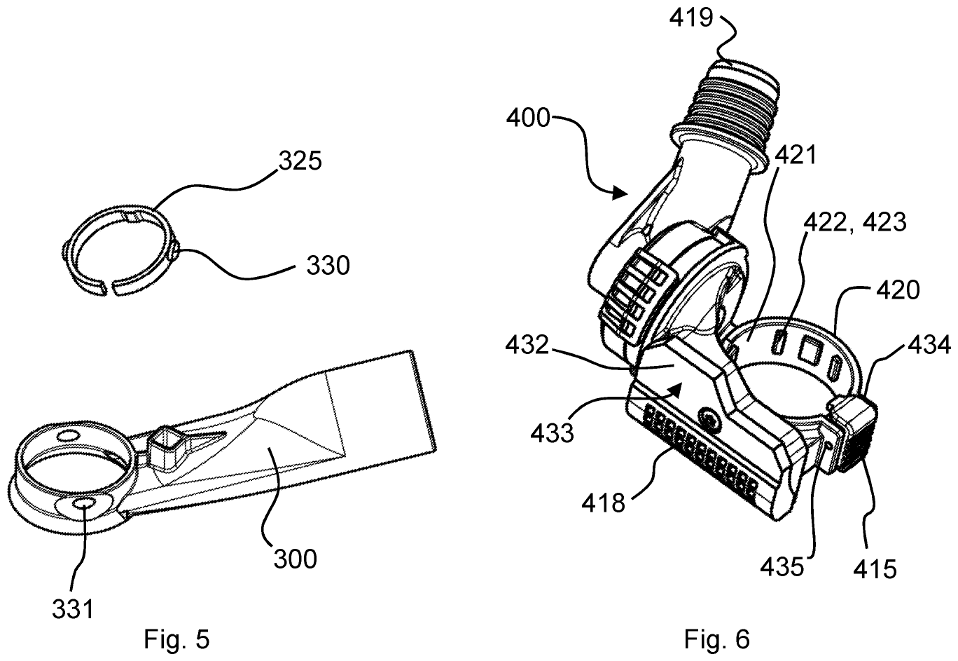

In FIG. 5, an auxiliary ring 325 is likewise provided in addition to the third embodiment of the suction device 300. In this case, this ring has two detent lugs 330, which engage in detent openings 331 that are formed in the suction device 324 when the suction device 300 is placed on the auxiliary ring 325 that was mounted on the collar 7 beforehand.

FIG. 6 shows, likewise in a perspective view, a fourth embodiment of the suction device 400, which represents an attachment 8 for a handheld electric power tool 1 that can be driven in oscillation. The suction device 400 according to the fourth embodiment has, in this case, a body 432, in which is formed an air duct 433, which is delimited at one end by an air inlet 418 and at the other end by an air outlet 419. Additionally formed on the body 432 is a mounting section 420, by means of which the suction device 400 can be mounted on the collar 7 of the handheld electric power tool 1. The mounting section 420 is designed as essentially a hollow cylinder here, as well, and has on its inner side 421 an encoding region 422 with a number of projections 423, which is used for installation of the suction device 400 on the collar 7 of the handheld electric power tool 1. Formed on the mounting section 420 in the exemplary embodiment shown is a locking device 415, with which it is possible for the user to lock the suction device 400 on the detent seats 14 of the collar 7, which is to say, in particular, to define their rotational position relative to the collar 7. The locking device 415 in this design is supported on the body 432 such that it can swivel about a swivel axis 435 in opposition to the force of a return spring 434. In addition, the air outlet 419 is supported on the body 432 such that it can pivot to a limited extent in order to provide the user with additional adjustment options.

FIG. 7 shows, in a side view, the handheld electric power tool 1 with the fourth embodiment of the suction device 400 mounted thereon. Mounted on the toolholder 3 in this case is a saw blade 17 serving as the tool 4.

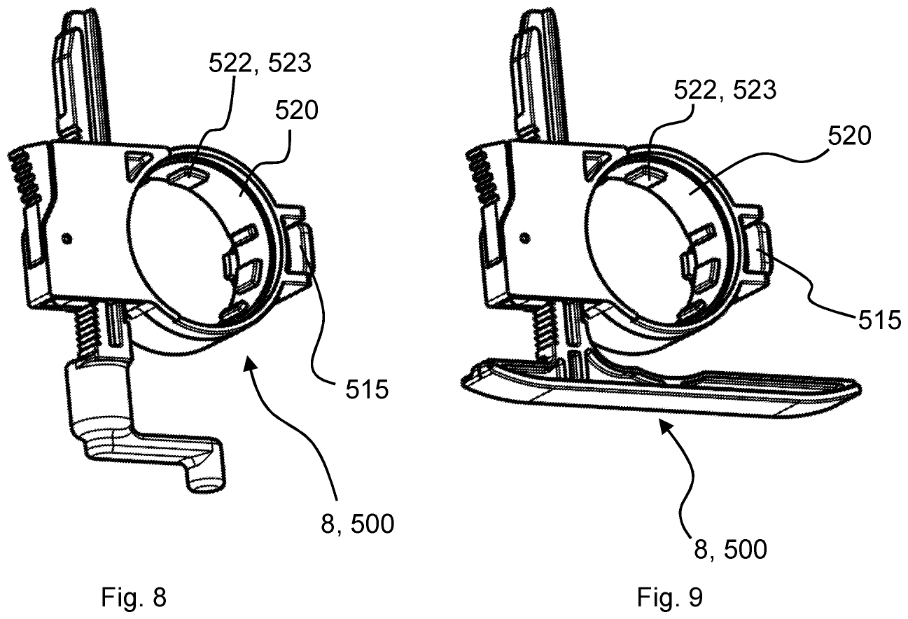

FIGS. 8 and 9 show two depth stops 500, which likewise serve as attachments 8. Common to both depth stops 500 is that they each have a mounting section 520, on which are likewise formed projections 523 that constitute an encoding region 522, and with which the depth stops 500 can be mounted on the collar 7 of the handheld electric power tool 1 through the encoding 13. The depth stop 500 that is shown in FIG. 8 is usually used in combination with a saw blade 17 designed as a plunge cut saw blade, whereas the depth stop 500 shown in FIG. 9 is used with a saw blade 17 in the manner of a circular saw. The two depth stops 500 each have a locking device 515, with which their rotational position on the collar 7 can be defined.

In the case of the handheld electric power tool 1 shown in FIG. 10, the attachment 8, which is designed as a suction device 100, is mounted on the collar 7 by means of the encoding 13 and the corresponding encoding region 122, and serves to draw off the dusts and chips produced during use of the tool 4, which in the exemplary embodiment shown is designed as an abrasive plate 18.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A handheld electric power tool that is adapted to be driven in oscillation, the handheld electric power tool comprising:
a housing; and
a drive arranged in the housing for driving a toolholder, which is arranged on a tool shaft coupled to the drive and on which a tool is detachably installed,
wherein the tool shaft is accommodated in an output unit, which includes a gearhead accommodated in a gearhead housing, and
wherein a collar, which is designed so as to make possible a tool-free seating of an attachment in an installation direction oriented parallel to a longitudinal axis of the gearhead, is formed on the output unit.

2. The handheld electric power tool according to claim 1, wherein the collar is associated with the gearhead or the gearhead housing.

3. The handheld electric power tool according to claim 1, wherein the collar is formed as a single piece with the gearhead or the gearhead housing.

4. The handheld electric power tool according to claim 1, wherein the collar has a cylindrical cross section.

5. The handheld electric power tool according to claim 1, wherein the collar is delimited at its end pointing toward the toolholder by a collet.

6. The handheld electric power tool according to claim 5, wherein at least one recess is formed on the collet to produce an encoding.

7. The handheld electric power tool according to claim 6, wherein the at least one recess is provided in multiple instances.

8. The handheld electric power tool according to claim 6, wherein the number of recesses is 2 or more, greater than 4 or more, greater than 6 or more, 14 or fewer, 12 or fewer, 10 or fewer, or is 8.

9. The handheld electric power tool according to claim 6, wherein an angular range of the total of the recesses is between 40° and 90°, or is 60°.

10. The handheld electric power tool according to claim 6, wherein the encoding has mirror-image symmetry about a plane of symmetry that is spanned by a housing longitudinal axis of the housing and the longitudinal axis of the gearhead.

11. The handheld electric power tool according to claim 10, wherein at least one of the recesses is intersected by the plane of symmetry.

12. The handheld electric power tool according to claim 6, wherein the encoding produced by the at least one recess is designed such that a placement of an attachment only takes place in a position that is not normally employed for use of the attachment.

13. The handheld electric power tool according to claim 1, wherein the end of the collar pointing away from the toolholder is delimited by an annular band.

14. The handheld electric power tool according to claim 1, wherein detent seats are formed in the collar.

15. The handheld electric power tool according to claim 1, wherein an auxiliary ring with which an attachment is connected in a rotationally fixed manner, is associated with the collar in a freely rotatable and axially fixed manner.

16. The handheld electric power tool according to claim 15, wherein the auxiliary ring has a radial opening.

17. The handheld electric power tool according to claim 15, wherein at least one radial projection is associated with the auxiliary ring on its end pointing toward the toolholder.

18. The handheld electric power tool according to claim 15, wherein at least one detent lug is associated with the auxiliary ring.

19. The handheld electric power tool according to claim 15, wherein an annular shoulder is associated with the auxiliary ring on its end pointing away from the toolholder.

20. The handheld electric power tool according to claim 19, wherein the annular shoulder at least partially covers the annular band.

21. A combination of a handheld electric power tool according to claim 1 and an attachment that is detachably accommodated on the collar of the gearhead housing, wherein the attachment has a hollow cylindrical mounting section that is adapted to be coupled to the collar.

22. The combination according to claim 21, wherein a plurality of projections for interaction with the recesses of the collar, a plurality of locking gates for interaction with the radial projections formed on the auxiliary ring, or detent openings for interaction with the detent lugs formed on the auxiliary ring are formed on an inner side of the hollow cylindrical mounting section.

23. The combination according to claim 21, wherein the attachment is a suction device, a depth stop, or a table support.
